(19) United States
(12) Patent Application Publication
(10) Pub. No.: US 2026/0241944 A1
(43) Pub. Date: Aug. 20, 2026

(54) VEHICLE STATE MACHINE

(71) Applicant: Rivian IP Holdings, LLC, Irvine, CA (US)

(72) Inventors: Armin Teymouri, San Pedro, CA (US); Chia-Chou Yeh, Torrance, CA (US)

(21) Appl. No.: 19/058,834

(22) Filed: Feb. 20, 2025

(51) Int. Cl. B60W 50/04; B60W 10/08; B60W 50/00

(52) U.S. Cl. CPC B60W 50/045; B60W 10/08; B60W 2050/0083; B60W 2400/00; B60W 2710/30

(57) ABSTRACT

A vehicle includes multiple controllers, each configured to control a respective module of multiple modules of the vehicle, the multiple modules including an electric motor module. The vehicle also includes a state machine communicatively coupled to the multiple controllers over a communications bus. The state machine is configured to collect data from the controllers, determine a state of the vehicle based on the collected data, in response to determining that the state of the vehicle includes a fault, classify whether the fault is retriable or non-retriable, and execute a fault handling procedure based on the classification. The state machine may be further configured to report the state of the vehicle to the communications bus, wherein the reporting includes a delay when the fault is retriable. The state machine may be further configured to execute the fault handling procedure during the delay.

### INTRODUCTION

A vehicle (e.g., an electric vehicle, a hybrid electric vehicle, or any other vehicle including electronic components) may incur any number of faults over the course of a lifetime of operation in the field. With electronically-enabled automation, the vehicle may seamlessly correct for certain faults with little to no disruption to a user of the vehicle (e.g., without having to stop the vehicle, and possibly without even notifying the user of the fault). By seamlessly correcting for suitable vehicle faults, the user experiences for drivers and passengers of the vehicle may be improved.

### SUMMARY

A vehicle may include a state machine to monitor respective statuses of multiple modules (e.g., a motor module, a battery module, a drivetrain module, a cabin control module, a display module, a communications module, any other suitable module, or any combination thereof) of the vehicle. In case any module of the vehicle incurs a fault, a state machine may be configured to detect the fault, classify the fault, and execute a fault handling procedure based on the classification. The corresponding fault handling procedure may be configured to clear retriable faults (i.e., faults that the state machine can attempt to correct multiple times) or non-retriable faults (i.e., the state machine cannot attempt to correct the fault multiple times). By identifying retriable faults and corresponding fault handling procedures, the state machine may be configured to clear faults (e.g., recover hardware of the corresponding module to a default or otherwise operational state) without significantly interrupting operation of the vehicle (e.g., without causing the vehicle to be stationary or to reboot).

In accordance with embodiments of this disclosure, a vehicle includes multiple controllers, each configured to control a respective module of multiple modules of the vehicle, the multiple modules including an electric motor module. The vehicle also includes a state machine communicatively coupled to the multiple controllers over a communications bus. The state machine is configured to collect data from the controllers, determine a state of the vehicle based on the collected data, in response to determining that the state of the vehicle includes a fault, classify whether the fault is retriable or non-retriable, and execute a fault handling procedure based on the classification. Methods of operating the state machine are also provided, as is a non-transitory computer-readable-medium having non-transitory computer-readable instructions encoded thereon that are executable by a processer of the state machine.

In some embodiments, the state machine is further configured to report the state of the vehicle to the communications bus, wherein the reporting includes a delay when the fault is retriable.

In some embodiments, when the fault is retriable, the state machine is configured to execute the fault handling procedure during the delay.

In some embodiments, to determine the state of the vehicle includes selecting from a plurality of states comprising: a default state, a fault retry attempt state, a fault retry pass state, and a fault retry fail state.

In some embodiments, to determine the state of the vehicle further includes entering the fault retry attempt state when the fault is retriable, and entering one of the default state or the fault retry fail state based on an outcome of the execution of the fault handling procedure.

In some embodiments, to execute the fault handling procedure includes entering the fault retry attempt state, determining that the fault retry attempt was successful, and entering the fault retry pass state based on the successful fault retry attempt.

In some embodiments, the fault handling procedure includes attempting to clear a fault, waiting for a delay, and monitoring for whether the fault is cleared after the delay.

In some embodiments, the fault comprises at least one of a hardware fault or an embedded fault.

In some embodiments, to execute the fault handling procedure includes attempting to clear the fault by resetting a module of the vehicle and restoring the module to a default state.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative block diagram of components of a vehicle including a state machine, in accordance with some embodiments of the present disclosure;

FIG. 2 shows an illustrative block diagram of some states of the state machine and transitions between the states, in accordance with some embodiments of the present disclosure;

FIG. 3 shows an illustrative block diagram of actions associated with a retriable fault handling procedure of the state machine, in accordance with some embodiments of the present disclosure;

FIG. 4 shows an illustrative flowchart of actions associated with clearing hardware faults using the state machine, in accordance with some embodiments of the present disclosure;

FIG. 5 shows an illustrative timing diagram associated with clearing hardware faults using the state machine, in accordance with some embodiments of the present disclosure;

FIG. 6 shows an illustrative flowchart of actions associated with hardware reset operations of the state machine, in accordance with some embodiments of the present disclosure;

FIG. 7 shows an illustrative flowchart of actions associated with successfully clearing a fault using the state machine, in accordance with some embodiments of the present disclosure;

FIG. 8 is an illustrative flowchart of actions associated with clearing fault latches using the state machine, in accordance with some embodiments of the present disclosure;

FIG. 9 shows an illustrative block diagram of actions associated with an immobile fault handling procedure of the state machine, in accordance with some embodiments of the present disclosure;

FIG. 10 shows an illustrative block diagram a motor fault handling procedure of the state machine, in accordance with some embodiments of the present disclosure;

FIG. 11 shows illustrative timing diagrams associated with operations of an electric vehicle state machine; and

FIG. 12 shows an illustrative flowchart of a method for operating a vehicle state machine, in accordance with some embodiments of the present disclosure.

### DETAILED DESCRIPTION

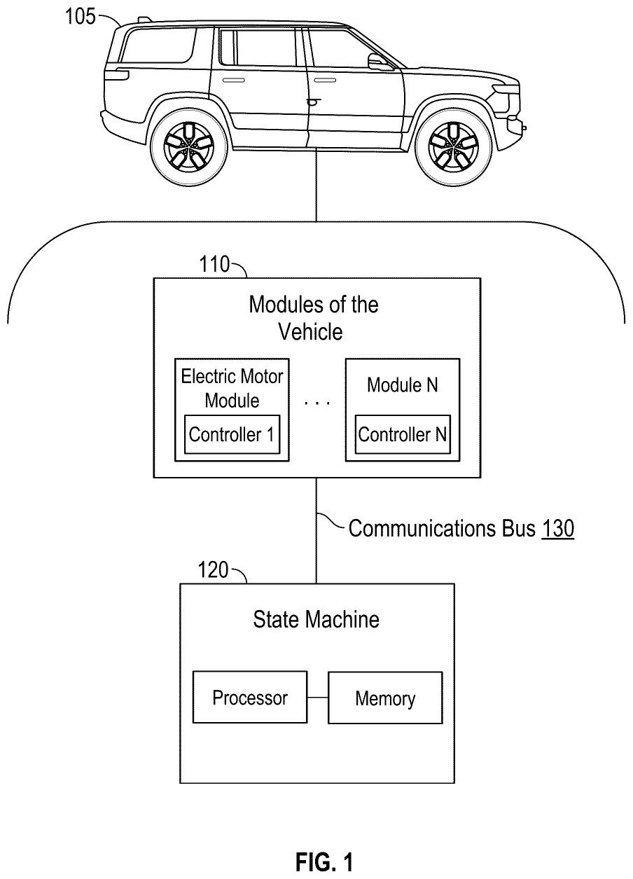

FIG. 1 shows an illustrative block diagram of components of vehicle 105 including modules of the vehicle 110 and state machine 120, in accordance with some embodiments of the present disclosure. The state machine 120 may include a processor (e.g., to execute non-transitory computer-readable instructions) and memory (e.g., a non-transitory computer-readable medium storing the non-transitory computer-readable instructions), which may be coupled to each other. The modules of the vehicle 110 may include any suitable number of modules (e.g., such as N modules, where N is any integer), each module having a respective controller, as shown. Among the modules is an electric motor module (e.g., as may be used in an electric vehicle or a hybrid vehicle), as shown. The other modules may include one or more additional motor modules (e.g., for a multi-motor vehicle), a battery module, a drivetrain module, a cabin control module, a display module, a communications module, or any other suitable module. Each of these modules may be susceptible to respective faults. As used herein, a fault may generally refer to any instance in which a module of the vehicle is not operating normally. A fault may occur because of a hardware issue, a software issue, a firmware issue, a battery issue, a motor issue, a network connectivity issue, any other suitable issue, or any combination thereof.

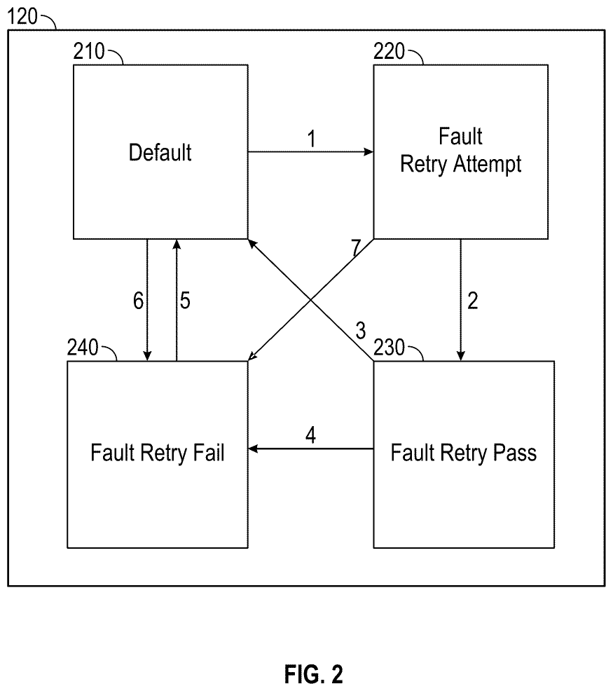

Each module of the vehicle 105 includes at least one respective controller configured to control at least an aspect of the corresponding module of the vehicle. State machine 120 is communicatively coupled to these controllers of the modules of the vehicle 110 over communications bus 130, which may be a controller area network (CAN) bus. Based on the communicative coupling, state machine 120 is configured to collect data from the controllers, determine a fault of the vehicle 105, optionally select one or more state of the vehicle (e.g., where the state may be selected from the states shown in FIG. 2, or may include any other suitable state), classify whether the fault is retriable or non-retriable, and execute a fault handling procedure based on the classification.

FIG. 2 shows an illustrative block diagram of some states of the state machine 120 and transitions between the states, in accordance with some embodiments of the present disclosure. The states include a default state 210 (e.g., a state in which there are no faults, or at least no detected faults), a fault retry attempt state 220, a fault retry pass state 230, and a fault retry fail state 240. The numbered and directional connections between those respective states indicate possible state transitions that may occur in state machine 120, the transitions causing the state machine 120 to exit one state and to enter another state, as indicated by the arrows. The states shown in FIG. 2 correspond to fault retry states (e.g., that may be activated when attempting to resolve a retriable fault). Though not explicitly shown, state machine 120 can also include additional states, such as states corresponding to a fault mode in which a fault is non-retriable.

Embodiments of states 220, 230, and 240, each of which may occur following the detection of a fault, may be implemented under mobile fault retry or immobile fault retry conditions. The mobile fault retry and the immobile fault retry are distinct fault handling procedures that may be executed in a sequential manner as described below.

The mobile fault retry procedure initiates promptly following fault detection. This procedure serves to maintain uninterrupted operation of the vehicle by executing at least one fault handling procedure while maintaining drivability and, in some embodiments, without notifying a driver of the vehicle that a fault has been detected.

The immobile fault retry procedure may be activated exclusively when the state machine has transitioned into fault mode. For example, the fault mode may correspond to a state that is distinct from those shown in FIG. 2, as mentioned above. The immobile fault retry procedure serves to restore the vehicle to normal operation (e.g., after executing the mobile fault retry procedure, but failing to return to the default state 210) when the vehicle is immobile.

In some embodiments, the vehicle 105 is in motion and incurs a fault; the state machine 120 detects the fault (e.g., by collecting data from controllers of the vehicle and determining a state of the vehicle based on the data) and implements the mobile fault retry procedure, including cycling through at least three of the states shown in FIG. 2; the mobile fault retry procedure fails to restore the vehicle to default state 210; as a result, the vehicle is immobilized; and while immobile, the state machine 120 implements the immobile fault retry procedure to swiftly return the vehicle to default state 210 (e.g., within milliseconds) without having to reset the vehicle.

When the vehicle 105 operates without any faults, it remains in the default state 210. When a fault occurs, the state machine 120 classifies the fault as retriable or non-retriable, as mentioned above. In response to classifying the fault as non-retriable, state machine 120 executes (e.g., without any delay) a fault handling procedure that is denoted herein as the fault action procedure. In response to classifying the fault as retriable, the state machine 120 executes transition 1 of FIG. 2, from default state 210 to fault retry attempt state 220.

In some embodiments, the state machine 120 is configured to communicate a fault status message to modules of the vehicle 110 over communications bus 130 with a delay. That is, the state machine is configured to report the state of the vehicle to the communications bus with a delay. The delay is included when the fault is retriable, and it also may be included when the faut is non-retriable. The duration of the delay is configured such that at least one attempt can be made to resolve the fault before it is communicated to at least one of the modules of the vehicle 110. That is, the state machine 120 may be configured to execute at least part of a fault handling procedure prior to communicating the fault over the communications bus 130.

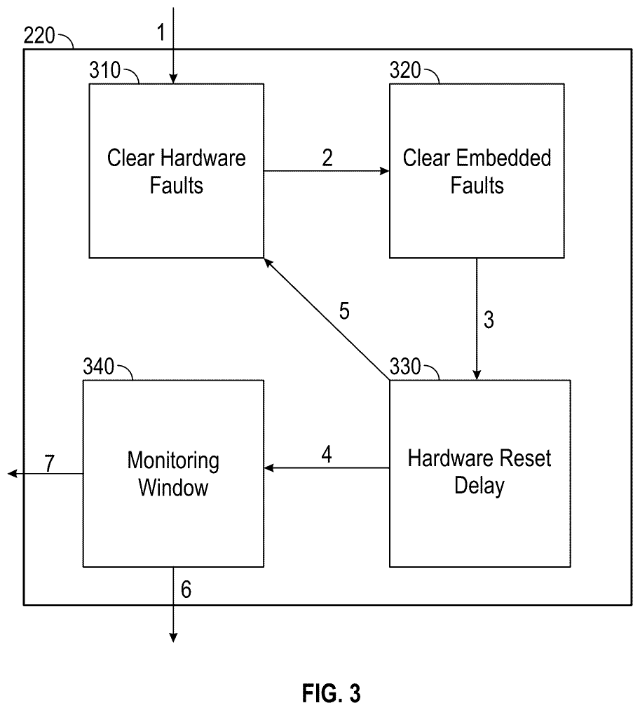

FIG. 3 shows an illustrative block diagram of actions associated with a retriable fault handling procedure of the state machine, in accordance with some embodiments of the present disclosure. In some embodiments, the retriable fault handling procedure shown in FIG. 3 corresponds to the fault retry attempt state 220.

In some embodiments, the fault handling procedure of FIG. 3 includes ongoing execution of gate drive command Insertion and fault retry running flag actions. The gate drive command Insertion inserts an appropriate gate drive command immediately upon the fault's activation. This inserted gate drive command may remain unchanged until the fault retry attempt state 220 transitions to a different state shown in FIG. 2. The fault retry running flag action (e.g., setting the flag to ‘true’) indicates that a fault retry handling procedure is running. This flag serves to denote the ongoing execution of fault retry operations.

In some embodiments, upon entry into the fault retry attempt state 220, values of all Fault Masks (e.g., values indicating a fault or non-fault status of various controllers of the vehicle) are stored. Thus, in case Fault Mask values are modified during the fault handling procedure, these values can be restored to their original (i.e., before execution of the fault handling procedure) states after the fault handling procedure is completed.

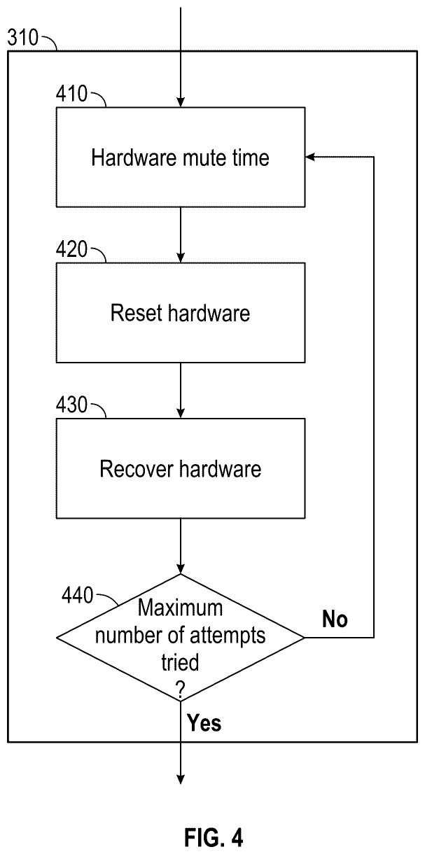

FIG. 4 shows an illustrative flowchart of actions associated with clearing hardware faults using the state machine, in accordance with some embodiments of the present disclosure. In some embodiments, these actions associated with clearing hardware faults correspond to the clear hardware faults operation 310 of FIG. 3. In fault retry attempt state 220, during clear hardware fault operations 310, the state machine 120 attempts to rectify the root cause of one or more hardware faults. This aspect of the fault handling procedure may include sending pulses, shutdown commands, zero signals, or other suitable controls, to specific hardware components. For example, those controls may be sent using predetermined application programming interfaces (APIs) and hardware pins.

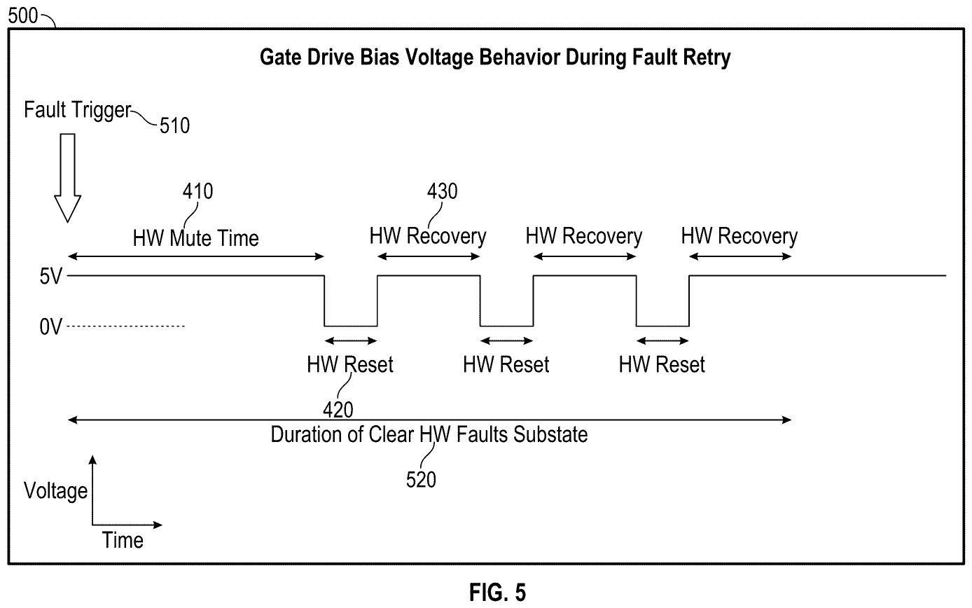

Clear hardware (HW) fault operations 310 includes HW mute time 410. During HW mute time 410, the state machine 120 waits for the mute time duration to pass before attempting to clear the one or more hardware faults. The length of this waiting period is configured based on HW specifications, e.g., that necessitate a minimum wait time after a fault occurrence before clearing that fault using a corresponding reset mechanism. During the mute time, appropriate fault action and gate drive status signals are executed based on the fault status, as further shown and described at least in connection with FIG. 5. The duration of HW mute time 410 can vary based on the fault, based on a state of the fault retry inverter (e.g., as further described below), based on any other suitable criteria, or based on any combination thereof. This duration may be determined by various calibration signals, such as signals indicating a hardware mute time while running, hardware mute time before running (i.e., in a pre-operation period), and hardware mute time while standby.

After waiting for hardware mute time 410, the state machine 120 continues with the clear hardware fault operations 310 by proceeding to reset hardware 420. During reset hardware 420, the state machine 120 sends out at least one hardware reset signal. The duration of transmitting the reset hardware signal may be set according to the hardware or according to the fault, e.g., based on one or more calibration signals as may indicate a hardware pulse width for reset and hardware pulse width for a long pulse indication. These signals may be sent by state machine 120 to clear hardware faults during a Run State of the vehicle (e.g., where the run state may correspond to the default state 210). hardware pulse width for a long pulse indication may be sent by state machine 120 to clear hardware faults in states other than the Run State.

While state machine 120 executes clear hardware fault operations 310, the state machine 120 may also evaluate various conditions (e.g., based on collecting data from controllers of the vehicle) and determine, based on the evaluation, whether and how to dispatch the one or more reset hardware signals 420. For example, the state machine 120 may determine that suitable conditions are not met and therefore the one or more reset hardware signals 420 may be withheld. Even if reset hardware signals 420 are withheld, the state machine 120 may still, as part of the clear hardware fault operations 310, execute other operations at 420 to increment a counter (e.g., to increment for the duration specified by the hardware pulse width for reset calibration).

The state machine 120 may be configured to dispatch one or more reset hardware signals 420 based on specific hardware of modules of the vehicle 110. For example, the reset hardware signals 420 may be dispatched when at least one fault is classified as a retriable fault. In some embodiments, there are two functions, retriable fault function operating on T0 timescale, and retriable fault function operating on T1 timescale, executed to classify a fault (e.g., as retriable or non-retriable). In some embodiments, the state machine determines that a run mode switching frequency is low (e.g., 2.5 kHz), and the reset hardware signals 420 are withheld due to the low sampling rate.

After completing any of the possible actions mentioned above in connection with the operations at 420, the state machine 120 proceeds to recover hardware 430. During the recover hardware operations 430, at least one faulty hardware component may be restored to its default state based on the one or more reset hardware signals 420. In some embodiments, the duration of the recover hardware operations 430 is determined based on specific hardware of modules of the vehicle 110 (e.g., as set by a calibration signal indicating a hardware recovery time).

After attempting to recover hardware 430, the state machine 120 evaluates, at 440, whether a maximum number of hardware reset attempts have been tried. If a maximum number of attempts have not been tried, then the state machine 120 returns to the execute the operations at hardware mute time 410 and the subsequent actions. If a maximum number of attempts have been tried, or if an attempt is successful at recovering hardware 430, the state machine 120 may proceed to the operations at clear embedded faults 320. For a retriable fault, the maximum number of attempts may be at least two. More than one attempt may be made to recover hardware 430 if prior attempts do not successfully recover the hardware to a default state. In some embodiments, each of multiple attempts is executed within a single instance of operation in the fault retry attempt state 220. The maximum number of attempts is set based on specific hardware of modules of the vehicle 110 (e.g., as set by a calibration signal indicating a maximum number of fault-handling attempts).

FIG. 5 shows an illustrative timing diagram 500 associated with clearing hardware faults using the state machine, in accordance with some embodiments of the present disclosure. The operations shown in timing diagram 500 may occur in response to a fault trigger 510 (e.g., which may be received from a controller of the vehicle or which may be triggered by state machine 120 collecting data from controllers of the vehicle, determining a state of the vehicle based on the collected data, and determining that the state includes a fault). In particular, the operations shown in timing diagram 500 may occur in response to fault trigger 510 corresponding to a fault that is classified by the state machine 120 as a retriable fault. Thus, the operations shown in FIG. 5, which may correspond to those of the flowchart of FIG. 4, may constitute at least part of a fault handling procedure based on the classification.

As shown in FIG. 5, the Gate Drive Bias voltage (which is alternates between binary states, as indicated by illustrative voltage levels of 0 V and 5 V) is signal that may be utilized across multiple or even all modules of the vehicle 110 to clear hardware faults. In some embodiments, setting this voltage to zero for a specific duration can effectively eliminate faults at the hardware level. Over a duration 520, which corresponds to executing the clear hardware faults operations 310, state machine sequentially waits for hardware mute time 410 and executes three attempts of transmitting hardware reset signal 420 followed by transmitting hardware recovery signal 430. For example, as shown in FIG. 5, the third attempt to transmit hardware reset signal 420 and hardware recovery signal 430 may be the first attempt that successfully recovers the hardware, causing the state machine 120 to execute transition 2 as shown in FIG. 3, from clear hardware faults 310 to clear embedded faults 320.

According to such a transition, the clear embedded faults operations 320 are described in more detail. During the clear embedded faults operations 320, latches indicating faults are reset (e.g., based on communication with low-level software or with firmware). This process may involve resetting any suitable latch, such as in HVOVHW or in a FPGA Desat Status.

In some embodiments, state machine 120 checks for certain conditions to be met before executing the clear embedded faults operations 320. There are certain conditions under which clear embedded faults operations 320 may be withheld. For example, the clear embedded faults operations 320 may be withheld if a Desat fault in the CLEAR HW FAULTS State has not been successfully cleared, or if a Fault Action Sync (FAS) is attempting to synchronize a fault from a module of the vehicle (e.g., a motor, such as a motor opposite the motor that is being operated on by the state machine 120). In case one of these withhold conditions is met, the state machine may still, as part of the operations at 320, increment a counter without clearing any embedded faults.

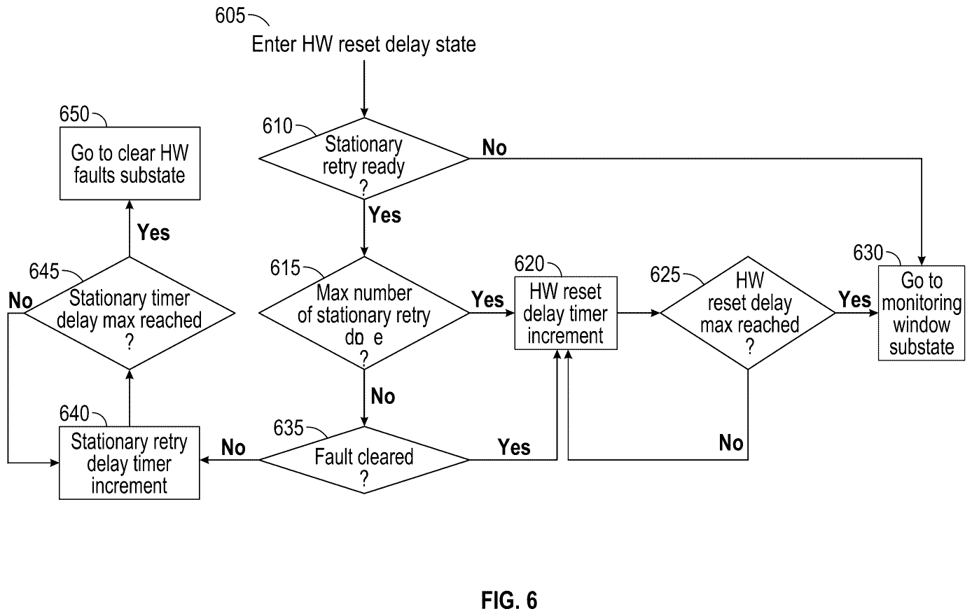

FIG. 6 shows an illustrative flowchart of actions associated with hardware reset operations of the state machine, in accordance with some embodiments of the present disclosure. The actions of FIG. 6 may collectively be referred to as a Stationary Fault Retry. In some embodiments, the Stationary Fault Retry procedure corresponds to hardware reset delay operations 330. As shown by the various paths of the flowchart of FIG. 6, after the state machine 120 attempts to clear hardware faults (e.g., based on the operations at 310) and embedded faults (e.g., based on the operations at 320, which may clear firmware and/or low-level software faults), the state machine 120 may proceed to take various actions based on the operating condition of the inverter.

In some embodiments, an Inverter State Machine (e.g., which may be included as one module, or a part of one module, of the modules of the vehicle 110) is in a RUN State before fault detection (e.g., prior to transition 1 of FIG. 2). Under such conditions, the state machine 120 may proceed to perform the hardware reset without delay. That is, state machine 120 may bypass the other operations of FIG. 6 and proceed, based on the decision at 610, to entering the monitoring window at 630 (e.g., which may correspond to monitoring window 340).

In some embodiments, the decision at 610 may indicate that the conditions to perform a Stationary Fault Retry are satisfied (with these conditions being described below). As a result, state machine 120 applies a delay (e.g., with a duration that is based on hardware of the vehicle and communicated via a signal such as may indicate a Stationary Fault Retry standby timer length, or a pre-operation Stationary Fault Retry standby timer length) during which the unlatched values of all faults are monitored. After the duration of the delay has passed, if the unlatched values of the faults remain uncleared, another round of clear hardware faults operations 650 (e.g., which may correspond to clear hardware faults 310 and may be followed by another round of clear embedded faults operations 320) is initiated. That initiation is indicated by the procession of operations from 615, to 635, to 640, to 645, and to 650; it may similarly correspond to transition 5 of FIG. 2.

The state machine 120 may continuously evaluate the conditions that must be satisfied to perform the Stationary Fault Retry as per the decision at 610. For example, this evaluation may occur at the same frequency as communications over communications bus 130. At 615, state machine 120 evaluates whether a maximum number of stationary fault retry attempts have been conducted. For example, that maximum may be calibrated in the hardware via a signal such as indicating a maximum number of fault-handling attempts during a pre-operation period, or indicating a maximum number of fault-handling attempts during a Stationary Fault Retry period. As long as the unlatched value of the retriable fault remains uncleared and the maximum number of stationary retry attempts is not reached, the state machine 120 may cause the stationary fault retry operations (e.g., which may include the actions at 634, 640, 645, and 650) to continue.

During Stationary Fault Retry, after clearing either the unlatched fault signal or upon reaching the maximum number of attempts for stationary retry, state machine 120 advances to a secondary hardware reset delay block at 620. This delay provides for a proper hardware reset, e.g., when both hardware reset and embedded reset actions are needed. The duration of the hardware reset delay at 620 may vary depending on a state of state machine 120 (e.g., whether the state machine is in Standby or PreRun mode) and/or specifications of the hardware, with respective values calibrated, e.g., by signals indicating a rest delay standby time or a pre-operation reset delay time.

Additional details of Stationary Fault Retry are described as follows. Stationary Fault Retry may occur as a step in either of the mobile fault retry procedure or the immobile fault retry procedure. In some embodiments, Stationary Fault Retry operations occur when state machine 120 is in fault retry attempt state 220. In particular, Stationary Fault Retry may cause state machine 120 to progress through transitions 2, 3, and 5 (in that order) of FIG. 3, creating a loop to execute the iteratively execute the clear hardware fault operations 310 and the clear embedded fault operations 320 until one or more faults are cleared, or a maximum number of attempts occurs. In contrast, if state machine 120 progresses through transitions 2, 3, and 4 (in that order) of FIG. 3, it may be because one or more conditions for activating Stationary Fault Retry are not satisfied.

Conditions that may cause the Stationary Fault Retry procedure to be executed or bypassed are described as follows. Some, or all, of the following criteria must be satisfied every time that state machine 120 checks for the Stationary Fault Retry conditions (e.g., the conditions must be satisfied from start to finish of the operations of FIG. 6). At any time, if the state machine 120 determines that one of the conditions is not satisfied, state machine 120 may execute transition 4 of FIG. 3 and proceed to the operations of the monitoring window state 340. A first condition associated with the Stationary Fault Retry procedure is a flag that indicates the state machine 120 is ready to enter this mode (e.g., as calibrated by a mode ready signal). This flag may be determined based on the state machine or vehicle being in a pre-run or standby condition (e.g., as calibrated by a mode request signal). Moreover, certain tests (e.g., as calibrated by a latent test signal) should not be running for the mode flag condition to be satisfied. In addition, an FPGA must be ready for executing various operations. A second condition associated with the Stationary Fault Retry procedure is a flag that indicates the motor and wheel speed are below a threshold (e.g., as calibrated by a speed ready signal, which may be based on a calibration signal indicating an immobile fault retry speed threshold). A third condition associated with the Stationary Fault Retry procedure is a flag that indicates the motor torque is below a threshold (e.g., as calibrated by a torque ready signal). The value of the motor torque flag may be based on torque drive commands and/or torque measurements, as calibrated by signals such as torque achieved and torque command, which may be based on a calibration signal indicating a model that may be used for monitoring torque, e.g., based on a motor output. A fourth condition associated with the Stationary Fault Retry procedure is a flag that indicates the AC current (e.g., of the motor) is below a threshold (e.g., as calibrated by a current ready signal, which may be compared to a threshold based on the motor and calibrated by a signal indicating a reset current threshold). The value of the AC current flag may be based on a root mean square (rms) value of the AC current, which may be determined by a measurement and/or a calculation.

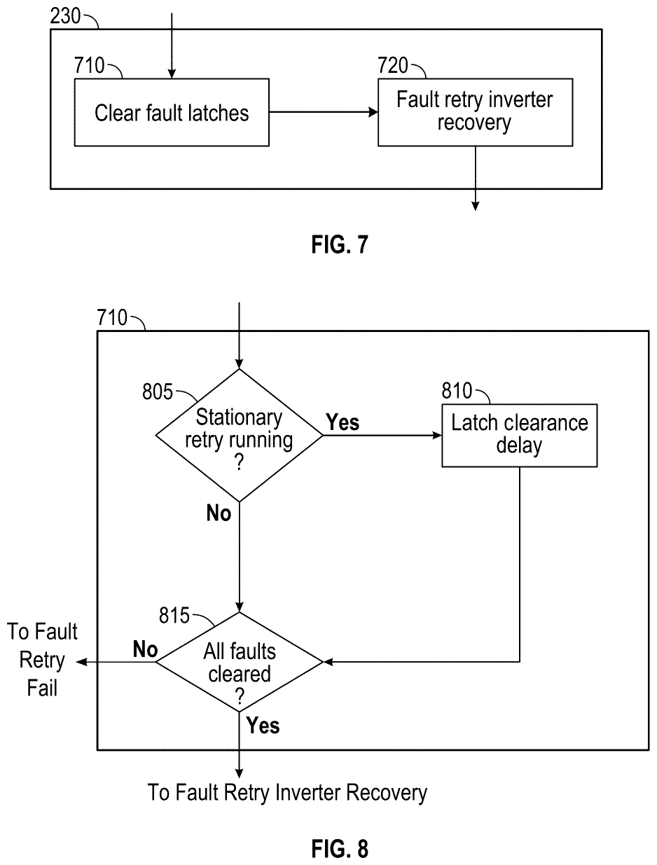

FIG. 7 shows an illustrative flowchart of actions associated with successfully clearing a fault using the state machine, in accordance with some embodiments of the present disclosure. In some embodiments, the actions that occur after clearing the fault, as shown in FIG. 7, correspond to the fault retry pass state 230.

When the fault retry attempt state 220 successfully clears the root cause (or causes) of the fault, state machine 120 proceeds to the fault retry pass state 230. In this state, as shown in FIG. 7, fault latches are cleared at 710. If that clearance of latches is successful, then the fault retry inverter is recovered at 720. The operations at 720 may include restoring one or more controllers (e.g., as may be associated with respective modules of the vehicle 110, and from which state machine 120 may collect data) to operate under conditions similar to, or substantially the same as, those before the fault retry process began.

FIG. 8 is an illustrative flowchart of actions associated with clearing fault latches using the state machine, in accordance with some embodiments of the present disclosure. In some embodiments, clearing the fault latches, as shown in FIG. 8, corresponds to the clear fault latches operations 710. The operations of FIG. 8 may cause some, or all, of the software latches for retriable faults to be cleared (e.g., restored to their conditions as in default state 210)

If a mobile fault retry procedure is ongoing, when executing the operations of FIG. 8, only the latches for mobile fault retry and stationary fault retry procedures, e.g., as may be monitored by a retriable fault function operating on T0 timescale and a retriable fault function operating on T1 timescale are cleared. Note that as used throughout this disclosure, T0 and T1 may correspond to frequencies at which communication with those latches occurs (e.g., where T1 may be greater than T0 to configure a delay in the communication, as described above).

However, if an immobile fault retry procedure is ongoing, when executing the operations of FIG. 8, the latches for all retriable faults may be cleared, e.g., as monitored by a retriable fault function operating on T0 timescale, as monitored by a retriable fault function operating on T1 timescale, and as further monitored by an immobile fault retry function operating on T1 timescale.

As shown in FIG. 8, clearing latches may depend on whether or not a Stationary Fault Retry procedure is running, as shown at 805. If Stationary Fault Retry is running, then there may be a latch clearance delay 810 before checking whether all faults are cleared at 815; if not, then state machine 120 may proceed without delay to checking whether all faults are cleared at 815. If all faults are cleared at 815, then state machine 120 may proceed to fault retry inverter recovery, as described below; if not, then state machine 120 may transition (e.g., as per transition 4 of FIG. 2) to fault retry fail state 240.

The operations of FIG. 8 may terminate at a fault retry inverter recovery procedure. This procedure may be executed after all fault latches are cleared, to restore the system to pre-fault conditions. With this procedure, all motor control algorithms, controllers, and commands (e.g., of default state 210) are resumed. Additionally, Fault Masks are reverted to their pre-fault conditions, status indicators are switched to default values (e.g., gate drive status transitions to normal), and the inverter operates in its default normal operation mode. If all faults remain cleared through the fault retry inverter recovery procedure, then state machine 120 returns to default state 210; that is, execution of the fault handling procedure was successful.

In some embodiments, an immobile fault retry may be in progress when there is an attempt to begin the fault retry inverter recovery procedure. Under such conditions, beginning the fault retry inverter recovery procedure would cause the Inverter State Machine (e.g., which may be an aspect of state machine 120, or may be a state machine associated with any one of the modules of the vehicle 110) is commanded to transition to a mode request state (e.g., as calibrated by a signal such as a mode request signal).

Returning to the various states shown in FIG. 2, transitions 4, 6, and 7 all show how, from any state of state machine 120, the state machine can transition to fault retry fail state 240. For example, after trying (e.g., multiple times) and failing to clear a fault at 220, or after clearing a fault at 220 but failing to restore the system to a default state at 230, the state machine 120 may transition to fault retry fail state 240. For another example, the state machine 120 may transition directly from default state 210 to fault retry fail state 240 because a fault is non-retriable, or because any other condition is not satisfied for proceeding to fault retry attempt state 220.

In fault retry fail state 240, all Fault Masks are restored to their default (e.g., before the fault, or before trying to handle the fault) values. Additionally, various communication indicators are updated. For example, status and action indicators, such as fault status T0, fault status T1, and fault action, may be updated over communications bus 130. Accordingly, the Inverter State Machine may transition to a fault mode (e.g., Mode 64). Under fault retry fail state 240, a corresponding flag (e.g., allowing a fault retry process to occur) is set to ‘true’. While this flag is set to ‘true’, certain fault handling procedures (e.g., including, but not limited to, that shown in FIG. 2 and related FIGs) may be unable to activate, even from default state 210.

Some reasons why state machine 120 would enter fault retry fail state 240 include, but are not limited to, detection of a collision, receipt of a restart request (e.g., from an application layer of the vehicle software system), a change to the mode of the Inverter State Machine, classifying a fault as non-retriable, classifying a fault as an immobile fault during a mobile fault retry procedure, an inability to clear fault latches (e.g., as per the operations of FIGS. 7-8), or the presence of a successful fault retry having occurred too recently (e.g., as calibrated by a signal that sets a threshold amount of time associated with a delay between successive retry attempts).

It is possible that during the execution of a fault handling procedure for a retriable fault, an additional retriable fault occurs. State machine 120 may be configured that such an additional retriable fault does not interrupt the fault handling procedure. Indeed, state machine 120 may be configured to implement another fault handling procedure, or to expand the ongoing fault handling procedure, to clear the additional retriable fault.

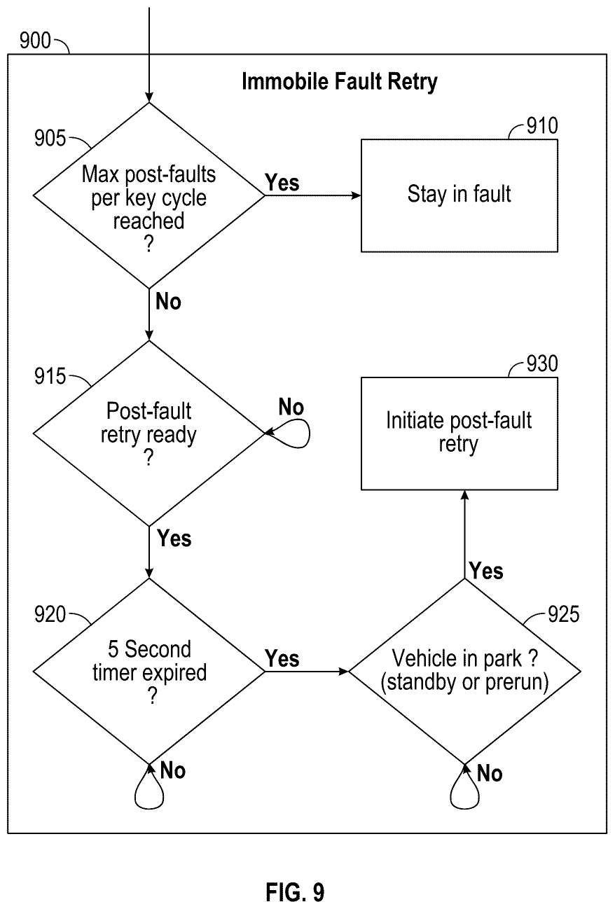

FIG. 9 shows an illustrative block diagram of actions associated with an immobile fault handling procedure (e.g., immobile fault retry) of the state machine, in accordance with some embodiments of the present disclosure. In some embodiments, the immobile fault handling procedure is executed when the Inverter State Machine is already in the Fault mode. That is, there may or may not have been a failed mobile fault handling procedure before initiating an immobile fault handling procedure. The immobile fault handling procedure may be initiated by the Inverter State Machine being in a fault mode (e.g., Mode 64), while all faults classified by the state machine (e.g., as communicated to modules of the vehicle 110 through signals such as fault statusT0 and fault statusT1) are retriable faults. For example, there may be three retry functions (e.g., a first function checking for all retriable faults on T0 timescale, a second function checking for all retriable faults on T1 timescale, and a third function checking for immobile retry faults on T1 timescale) that indicate whether all faults classified by the state machine are retriable faults. In some embodiments, a first frequency is associated with at least one of the three macros, and a second frequency, slower than the first, is associated with at least one other one of the three macros. The first frequency and the second frequency may be configured for delayed reporting of faults (e.g., such that a fault handling procedure may be executed on a retriable fault prior to reporting of the fault).

During Stationary Fault Retry, after clearing either the unlatched fault signal or upon reaching the maximum number of attempts for stationary retry, state machine 120 advances to a secondary hardware reset delay block at 620. This delay provides for a proper hardware reset, e.g., when both hardware reset and embedded reset actions are needed. The duration of the hardware reset delay at 620 may vary depending on a state of state machine 120 (e.g., whether the state machine is in Standby or PreRun mode) and/or specifications of the hardware, with respective values calibrated, e.g., by signals setting a reset delay length when operating in the standby or pre-operation periods.

Additional details of Stationary Fault Retry are described as follows. Stationary Fault Retry may occur as a step in either of the mobile fault retry procedure or the immobile fault retry procedure. In some embodiments, Stationary Fault Retry operations occur when state machine 120 is in fault retry attempt state 220. In particular, Stationary Fault Retry may cause state machine 120 to progress through transitions 2, 3, and 5 (in that order) of FIG. 3, creating a loop to execute the iteratively execute the clear hardware fault operations 310 and the clear embedded fault operations 320 until one or more faults are cleared, or a maximum number of attempts occurs. In contrast, if state machine 120 progresses through transitions 2, 3, and 4 (in that order) of FIG. 3, it may be because one or more conditions for activating Stationary Fault Retry are not satisfied.

Conditions that may cause the immobile fault retry procedure to be executed or bypassed are described as follows. Some, or all, of the following criteria may need to be satisfied every time that state machine 120 checks for the immobile fault retry conditions (e.g., the conditions must be satisfied from start to finish of the operations of FIG. 9). A first condition associated with the immobile fault retry is a flag that indicates the state machine 120 is ready to enter this mode (e.g., as calibrated by a signal flagging a readiness for operation in an immobile fault retry mode). This flag may be determined based on the state machine or vehicle being in a pre-run or standby condition (e.g., as determined by a mode status signal). A second condition associated with the immobile fault retry procedure is a flag that indicates the motor and wheel speed are below a threshold (e.g., as calibrated by a immobile fault speed ready signal, which may be based on a calibration signal such as an immobile fault speed threshold signal). A third condition associated with the immobile fault retry procedure is a flag that indicates the motor torque is below a threshold (e.g., as calibrated by a immobile fault torque ready signal). The value of the motor torque flag may be based on torque drive commands and/or torque measurements, as calibrated by signals such as a torque achieved or a torque command signal, which may be based on a calibration signal that applies a particular model for determining motor torque based on at least one motor output. A fourth condition associated with the immobile fault retry procedure is a flag that indicates the AC current (e.g., of the motor) is below a threshold (e.g., as determined based on an immobile fault retry current ready signal, which may be compared to a threshold based on the motor and calibrated by an immobile fault current threshold signal). The value of the AC current flag may be based on a root mean square (rms) value of the AC current, which may be determined by a measurement and/or a calculation. A fifth condition associated with the immobile fault retry procedure is a flag that indicates a Desat fault with hardware damage.

When the immobile fault retry conditions are satisfied, a timer is started. Upon timer expiration (e.g., after five seconds), the immobile fault retry process begins if the vehicle is immobile and if state machine 120 and/or Inverter State Machine are in proper modes.

In connection with the operations at 905, state machine 120 imposes a maximum allowable number of attempts to clear the fault within each key cycle. This maximum may be imposed by a signal such as an immobile fault maximum retry attempt signal. If the maximum limit is reached without clearing the fault, state machine 120 ceases to try additional immobile fault retry attempts for at least the duration of a current key cycle.

If, at 930, the immobile fault retry procedure is initiated, then state machine 120 may perform the following actions. State machine 120 may set an internal flag (e.g., PostFault) to transition from the fault retry fail state 240 to the default state 210 (e.g., as per transition 5 of FIG. 2). For example, a mobile fault retry procedure may have failed, causing the state machine 120 to be in the fault retry fail 240 state; then, after immobilizing the vehicle, the immobile fault retry procedure may require a return to default state 210 in order to proceed. While in default state 210, a flag (e.g., preventing a fault retry from being allowed) may be set to indicate that the fault handling procedure includes the immobile fault retry procedure.

The actions immobile fault retry procedure are further described as follows. The immobile fault retry procedure may correspond to a broader implementation of the mobile fault retry procedure. For example, the immobile fault retry procedure may include the same actions, or similar actions, as the mobile fault retry procedure, but with the inclusion of a new set of faults (e.g., that are checked for and attempted to clear). For example, a flag (e.g., indicating that only immobile faults have been determined) may cause certain faults to be handled that are only handled during the immobile fault retry procedure. Accordingly, state machine 120 may proceed to fault retry attempt state 220 and may take subsequent actions similar to those described in connection with FIGS. 2-8, albeit with broader fault handling coverage.

If the immobile fault retry procedure fails to handle the error, then state machine 120 ultimately transitions to fault retry fail state 240.

If the immobile fault retry procedure succeeds at handling the error, then state machine 120 returns to default state 210. Given how the vehicle is immobilized during the immobile fault retry procedure, there may be additional operations (e.g., as compared to those that follow the successful handling of an error using a mobile fault retry procedure) when returning to default state 210. For example, prior to returning to default state 210, state machine 120 may cause a command to be issued to logic (e.g., DTC Clear Logic) within the vehicle application-level software. During this step, the DTC Clear Logic will manage the Inverter State Machine Transition for one or more motors of the vehicle (e.g., for a first motor, Motor 1, and for a second motor, Motor 2). This management causes both motor states align respective modes of their Inverter State Machines (e.g., based on a mode request signal). Immobile fault retry is considered by state machine 120 to be successful when one or more motors' Inverter State Machines transitions to a default state (e.g., corresponding to default state 210).

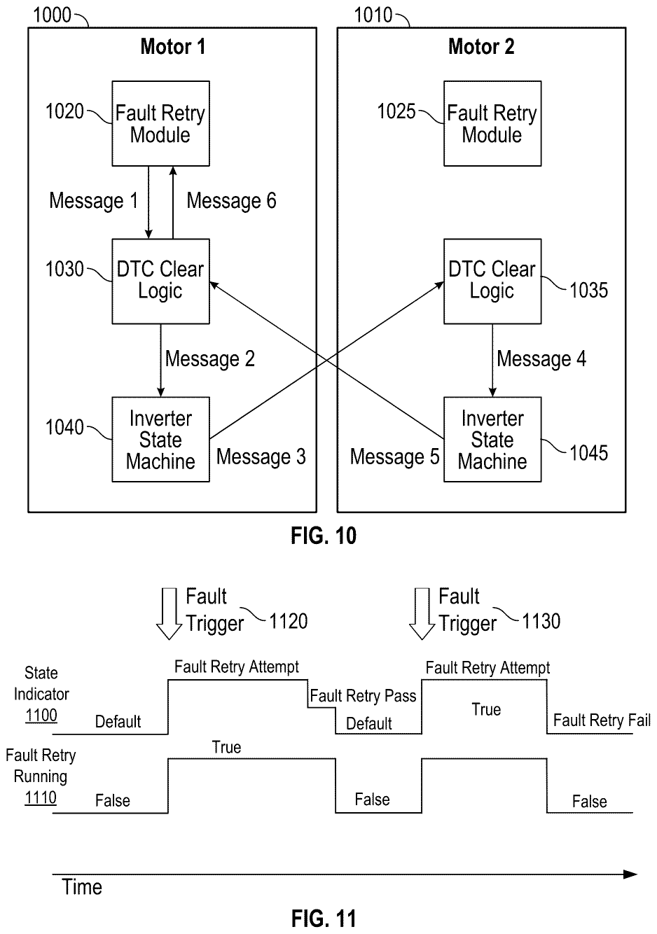

FIG. 10 shows an illustrative block diagram a motor fault handling procedure of the state machine, in accordance with some embodiments of the present disclosure. The motor fault handling procedure of FIG. 10 corresponds to a dual motor configuration; however, other motor configurations are considered. In some embodiments, the motor fault handling procedure of FIG. 10 is configured to occur following successful completion of an immobile fault retry procedure on one motor of multiple motors. As such, the operations of FIG. 10 synchronize the multiple motors and may cause the corresponding vehicle to be ready to mobilize.

With regard to the inter-component messages shown in FIG. 10, which may communicate any suitable information (e.g., such as fault statuses), if any of the messages indicate a failure, or fail to be received, both motors' Inverter State Machines will remain in, or return to, a Fault state. In some embodiments, messages 1-6 of FIG. 10 are configured as follows. Message 1 may follow a successful immobile fault retry in Motor 1 and triggers a DTC Clear in Motor 1. Message 2 may follow a successful completion of the DTC Clear in Motor 1, causing Motor 1 to transition its Inverter State Machine from a faulty state to a mode request state (e.g., as determined based on a mode request signal). Message 3 may follow the state transition of Motor 1 and instructs Motor 2 to perform a DTC Clear, thereby causing all synchronized faults caused by Motor 1 in Motor 2 to be cleared. Message 4 may follow successful DTC Clear in Motor 2 and initiate an Inverter State Machine transition out of a fault state. Message 5 may follow Motor 2's transition out of a fault mode and informs Motor 1's DTC Clear algorithm to finalize the process of returning to a default state. Message 6 may be transmitted when both motors' Inverter States are out of the fault mode, causing the DTC Clear operations in Motor 1 to conclude and sending a corresponding message to state machine 120, thereby marking the completion of the immobile fault retry procedure.

FIG. 11 shows illustrative timing diagrams associated with operations of an electric vehicle state machine. FIG. 11 shows the temporal progressions of state indicator signal 1100 and fault retry running signal 1110 in response to first fault trigger 1120 and then in response to second fault trigger 1130.

At first fault trigger 1120, state indicator signal 1100 transitions from default state 210 to fault retry attempt state 220, and fault retry running signal 1110 transitions from false to true (i.e., the fault retry process is being executed as a fault handling procedure). After at least one (and possibly multiple, e.g., as per being a retriable fault) attempt to clear the fault (e.g., as per the actions of FIGS. 3-6), the fault is successfully cleared, as indicated by the transition of state indicator signal 1100, as shown, to the fault retry pass state 230. Because there are additional actions (e.g., those of FIGS. 7-8) associated with operating in fault retry pass state 230, the fault retry running signal 1110 remains at true. After completing the actions of fault retry pass state 230, state indicator signal 1100 returns to default state 210 and fault retry running signal 1110 transitions to false.

Some time after clearing the fault of first fault trigger 1120, another fault occurs as indicated by second fault trigger 1130. At second fault trigger 1130, state indicator signal 1100 transitions from default state 210 to fault retry attempt state 220, and fault retry running signal 1110 transitions from false to true. After at least one (and possibly multiple, e.g., as per being a retriable fault) attempt to clear the fault (e.g., as per the actions of FIGS. 3-6), a maximum number of attempts is reached without successfully clearing the fault. Accordingly, state indicator signal 1100 transitions, as shown, to the fault retry fail state 240 and fault retry running signal 1110 transitions to false.

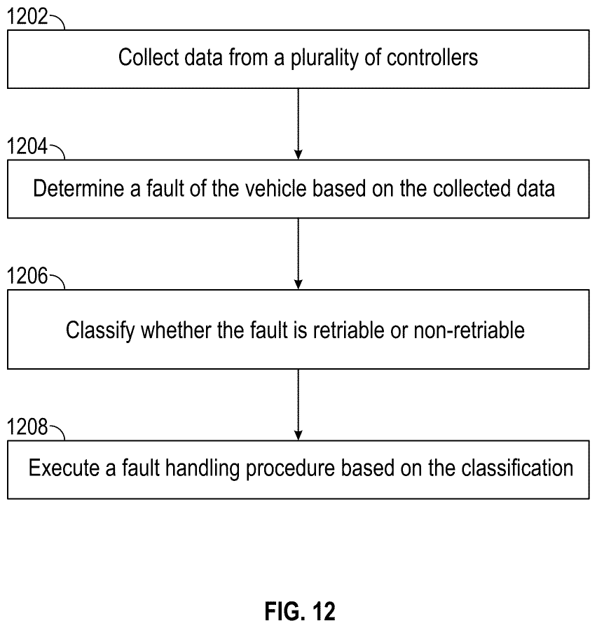

FIG. 12 shows an illustrative flowchart of a method for operating a vehicle state machine, in accordance with some embodiments of the present disclosure. For example, the method of FIG. 12 may be performed by state machine 120.

At 1202, data is collected from a plurality of controllers (e.g., respective controllers of modules of the vehicle 110). At 1204, a fault of the vehicle is determined based on the elected data. At 1206, the fault is classified as retriable (e.g., including as a mobile retry fault or an immobile retry fault) or non-retriable. At 1208, a fault handling procedure (e.g., including any permutation of the operations described in connection with FIGS. 2-10) is executed based on the classification. The fault handling procedure may be a mobile fault retry, an immobile fault retry, a Stationary Fault Retry, any other operations described in this disclosure in connection with clearing faults, or any combination thereof.

In some embodiments, the method of FIG. 12 includes a delay reporting of the fault after a faulty state has been determined. This delay may be specific to retriable faults, such that the delayed reporting is part of a fault handling procedure that is executed based on the classification of a retriable fault. For example, state machine 120 may be configured to report the fault after executing the fault handling procedure (whether or not the procedure succeeds in handling the fault and restoring a default state).

In some embodiments, when the fault handling procedure includes a mobile fault retry and an immobile fault retry, the state machine 120 may be configured to report the failure of mobile fault retries (e.g., including the faulty hardware, as well as a number of failure attempts) prior to initiating the immobile fault retry.

As mentioned above, those skilled in the art will appreciate how many types of calibration signals and application programming interfaces (APIs) may be used to execute the actions and transitions of state machine 120, and to execute the actions of other modules of the vehicle 110 with which state machine 120 communicates. For example, various calibration signals may apply conditions under which various fault handling procedures are permitted, may calibrate communication delays as per trying to resolve a fault prior to communicating it, may apply a maximum number of retry attempts based on a given hardware, may apply signal delays as could be required to interact with certain hardware systems or latches, or may otherwise support fault handling of a vehicle consistent with implementations of the subject matter of this disclosure. Similarly, various APIs may be used to communicate between state machine 120 and modules of the vehicle 110, to communicate between state machine 120 and one or more on-board field programmable gate arrays, to control various latches, to instantiate or abort various states or corresponding operations, or to otherwise support fault handling of a vehicle consistent with implementations of the subject matter of this disclosure. These APIs may use any suitable message content and/or message protocol to communicate information to and from state machine 120, including to share various calibration signals as mentioned above.

In some embodiments, state machine 120 stores, or otherwise retrieves from memory, a list of retriable faults. Thus, in response to determining that a state of vehicle 105 includes a fault, state machine 120 may classify the fault as retriable or non-retriable based on inspection of the list of retriable faults. The list may further classify retriable faults based on whether the faults can be handled using mobile fault retry, immobile fault retry, or both. The list may further classify retriable faults based on a communication delay (e.g., which may be of length T0 or of length T1) associated with the corresponding fault handling procedure.

As used herein, clearing a fault may be synonymous with handing, or resolving, the fault (e.g., as part of a fault handling procedure. Clearing the fault may cause a faulty component of a vehicle to return to a default state (e.g., that is free of faults).

The processes described above are intended to be illustrative and not limiting. One skilled in the art would appreciate that the steps of the processes described herein may be omitted, modified, combined and/or rearranged, and any additional steps may be performed without departing from the scope of the invention.

The foregoing is merely illustrative of the principles of this disclosure, and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations thereto and modifications thereof, which are within the spirit of the following claims.

What is claimed is:

1. A vehicle comprising:
a plurality of controllers, each configured to control a respective module of a plurality of modules of the vehicle, the plurality of modules comprising an electric motor module; and
a state machine communicatively coupled to the plurality of controllers over a communications bus, wherein the state machine is configured to:
collect data from the plurality of controllers;
determine a fault of the vehicle based on the collected data;
classify whether the fault is retriable or non-retriable; and
execute a fault handling procedure based on the classification.

2. The vehicle of claim 1, wherein the state machine is further configured to report the fault of the vehicle to the communications bus, wherein the reporting comprises a delay when the fault is retriable.

3. The vehicle of claim 2, wherein, when the fault is retriable, the state machine is configured to execute the fault handling procedure during the delay.

4. The vehicle of claim 1, further comprising selecting a state of the vehicle from a plurality of states comprising: a default state, a fault retry attempt state, a fault retry pass state, and a fault retry fail state.

5. The vehicle of claim 4, wherein to execute the fault handling procedure comprises:
entering the fault retry attempt state when the fault is retriable; and
entering one of the default state or the fault retry fail state based on an outcome of the execution of the fault handling procedure.

6. The vehicle of claim 4, wherein to execute the fault handling procedure comprises:
entering the fault retry attempt state;
determining that the fault retry attempt was successful; and
entering the fault retry pass state based on the successful fault retry attempt.

7. The vehicle of claim 1, wherein to execute the fault handling procedure comprises attempting to clear a fault, waiting for a delay, and monitoring for whether the fault is cleared after the delay.

8. The vehicle of claim 7, wherein the fault comprises at least one of a hardware fault or an embedded fault.

9. The vehicle of claim 7, wherein to execute the fault handling procedure comprises attempting to clear the fault by resetting a module of the vehicle and restoring the module to a default state.

10. A method comprising:
collecting, using a state machine, data from a plurality of controllers, wherein the state machine is communicatively coupled to the plurality of controllers over a communications bus, and the plurality of controllers are each configured to control a respective module of a plurality of modules of a vehicle, the plurality of modules comprising an electric motor module;
determining, using the state machine, a fault of the vehicle based on the collected data;
classifying, using the state machine, whether the fault is retriable or non-retriable; and
executing a fault handling procedure based on the classification.

11. The method of claim 10, further comprising reporting the state of the vehicle to the communications bus, wherein the reporting comprises a delay when the fault is retriable.

12. The method of claim 11, wherein, when the fault is retriable, the fault handling procedure is executed during the delay.

13. The method of claim 10, further comprising selecting a state of the vehicle from a plurality of states comprising: a default state, a fault retry attempt state, a fault retry pass state, and a fault retry fail state.

14. The method of claim 13, wherein executing the fault handling procedure comprises:
entering the fault retry attempt state when the fault is retriable; and
entering one of the default state or the fault retry fail state based on an outcome of the execution of the fault handling procedure.

15. The method of claim 13, wherein executing the fault handling procedure comprises:
entering the fault retry attempt state;
determining that the fault retry attempt was successful; and
entering the fault retry pass state based on the successful fault retry attempt.

16. The method of claim 10, wherein executing the fault handling procedure comprises:
attempting to clear a fault;
waiting for a delay; and
monitoring for whether the fault is cleared after the delay.

17. The method of claim 16, wherein the fault comprises at least one of a hardware fault or an embedded fault.

18. The method of claim 16, wherein executing the fault handling procedure comprises:
attempting to clear the fault by resetting a module of the vehicle; and
restoring the module to a default state.

19. A non-transitory computer-readable medium having non-transitory computer-readable instructions encoded thereon that, when executed by a processer of a state machine, cause the state machine to:
collect data from a plurality of controllers, wherein the state machine is communicatively coupled to the plurality of controllers over a communications bus, and the plurality of controllers are each configured to control a respective module of a plurality of modules of a vehicle, the plurality of modules comprising an electric motor module;
determine a fault of the vehicle based on the collected data;
classify whether the fault is retriable or non-retriable; and
execute a fault handling procedure based on the classification.

20. The non-transitory computer-readable medium of claim 19, wherein the instructions further cause the state machine to report the state of the vehicle to the communications bus, wherein the reporting comprises a delay when the fault is retriable.
